(19) United States
(12) Patent Application Publication
(10) Pub. No.: US 2005/0268993 A1
(43) Pub. Date: Dec. 8, 2005

(54) Permanent magnet alloy with improved high temperature performance

(75) Inventors: Ralph W. McCallum, Ames, IA (US); Youwen Xu, Mankato, MN (US); Matthew J. Kramer, Ankeny, IA (US); Iver E. Anderson, Ames, IA (US); Kevin W. Dennis, Ames, IA (US)

Correspondence Address: Edward J. Timmer, P.O. Box 770, Richland, MI, 49083, US

(73) Assignee: Iowa State University Research Foundation, Inc.

(21) Appl. No.: 11/126,484

(22) Filed: May 11, 2005

Related U.S. Application Data
(63) Continuation of application No. PCT/US03/36464, filed on Nov. 13, 2003.
(60) Provisional application No. 60/427,387, filed on Nov. 18, 2002.

(51) Int. Cl. H01F 1/057

(52) U.S. Cl. 148/302

(57) ABSTRACT

A permanent magnet material is provided and includes a major phase represented by MRE₂Tr₁₄X wherein MRE comprises Y and at least one other rare earth element with Y being present as 15% or more of the MRE on an atomic basis, Tr is a transition element, and X is an element selected from the group consisting of B and C.

This application claims the benefits of U.S. provisional application Ser. No. 60/427,387 filed Nov. 18, 2002.

### CONTRACTUAL ORIGIN OF THE INVENTION

The United States Government has rights in this invention pursuant to Contract No. W-7405-ENG-82 between the U.S. Department of Energy and Iowa State University, Ames, Iowa, which contract grants to Iowa State University Research Foundation, Inc. the right to apply for this patent.

### FIELD OF THE INVENTION

The present invention relates to a permanent magnet material which may be made either by rapid solidification processing, chill casting and the like and to sintered and bonded permanent magnets made therefrom having improved magnetic performance at temperatures above 100 degrees C.

### BACKGROUND OF THE INVENTION

Currently, high performance permanent magnets are based on two types of permanent magnet materials. One type of permanent magnet material is based on Nd₂Fe₁₄B, while the other type is based on Sm₂CO₁₇ and SmCo. At room temperature, Nd₂Fe₁₄B based magnets enjoy a considerable advantage over the Sm-Co type in terms of cost and performance. However, as a result of both a low Curie temperature and a large temperature dependence of the magnetocrystalline anisotropy, the performance of Nd₂Fe₁₄B magnets drops off rapidly with temperature above 100 degrees C. Past workers have attempted to improve the properties of Nd₂Fe₁₄B based magnets by alloy additions. The partial substitution of Co for Fe raises the Curie temperature, while the temperature dependence of the magnetocrystalline anisotropy is improved by the addition of a heavy rare earth element, such as Dy. Unfortunately, the addition of Co lowers magnetocrystalline anisotropy, while the addition of Dy lowers saturation magnetization. Furthermore, the amounts of elemental substitutions in the alloy is limited by phase diagram considerations. Current, Nd₂Fe₁₄B based magnets are based on compositions in which the Nd₂Fe₁₄B major phase decomposes peritectically to liquid and Fe. In addition, in the equilibrium phase diagram for RE=Nd or Pr, the Re₂Fe₁₄B major phase exists in equilibrium with a low melting point rare earth-rich eutectic. For rapidly solidified Nd₂Fe₁₄B based material, the presence of this liquid allows for substantial grain growth below 1100 degrees C. during processing.

High torque permanent magnet electric drive motors now are limited in operation temperature by the temperature dependence of the permanent magnets. This is true even for motors operating in an ambient temperature environment as a result of heating due to energy losses in the motor. For example, high torque permanent magnet electric motors now are limited to an operation temperature range of 120 to 150 degrees C. There is a desire to increase the operation temperature range up to 200 degrees C. while maintaining acceptable motor operating characteristics. Also, there is a desire to reduce the cost associated with sintered permanent magnets.

### SUMMARY OF THE INVENTION

The present invention provides in one embodiment a permanent magnet material, wherein at least a portion, preferably a majority, of the material includes a phase represented by MRE₂Tr₁₄X wherein MRE (mixed rare earth) comprises Y and at least one other rare earth element with Y being present as 15% or more, preferably 50% or more, of the MRE on an atomic basis, Tr is a transition element preferably selected from the group consisting of Fe and Co, and X is an element selected from the group consisting of B and C.

In another embodiment of the invention, a permanent magnet material is provided, wherein at least a portion, preferably a majority, of the material includes a phase represented by MRE₂Tr₁₄X wherein MRE comprises Y and at least one other rare earth element and wherein Y together with at least one heavy rare earth element selected from the group consisting of Dy, Er, Ho, and Tb are collectively present as 50% or more of the MRE on an atomic basis, Tr is a transition element, and X is an element selected from the group consisting of B and C.

The present invention provides in still another embodiment a permanent magnet alloy or composition comprising about 2 to about 20 atomic ? of Y, at least one other rare earth element so that the total rare earth content is about 3 to 21 atomic %, about 70 to about 96 weight % Tr where Tr is a transition element preferably selected from the group consisting of Fe and Co, and about 0.3 to about 5 atomic % X where X is selected from B and/or C.

The present invention provides in a further embodiment a permanent magnet material at least a portion of which includes a phase represented by MRE₂Tr₁₄X wherein MRE comprises Y and at least one other rare earth element, wherein a ratio of Y to a heavy rare earth element is in the range of 0.5 to 3.0 and wherein Y plus the heavy rare earth element is 15-6 or more of the MRE on an atomic basis, Tr is a transition element, and X is an element selected from the group consisting of B and C.

The major phase of a permanent magnet material or alloy pursuant to the invention decomposes peritectically on heating to MRE₂Tr₁₇ phase plus a liquid (e.g. liquid Tr with dissolved RE and X), or melts congruently.

A permanent magnet material pursuant to the invention can be produced by rapid solidification processes such as melt spinning or planar flow casting to make ribbon, flake, and fragments thereof or by melt atomization such as gas or centrifugal atomization to produce spherical powders which are used for bonded magnets wherein the magnet material is mixed with binder and formed to a magnet shape to provide a bonded permanent magnet of reduced cost. Alternately, the material can be chill cast and crushed for the fabrication of a sintered permanent magnet. A permanent magnet pursuant to the invention exhibits a reduced temperature dependence of magnetocrystalline anisotropy and saturation magnetization as compared that of a permanent magnet based on Nd₂Fe₁₄B at temperatures above about 100 degrees C. to about 200 degrees C.

### DESCRIPTION OF THE DRAWINGS

FIGS. 1a and 1b are magnetization-demagnetization curves at 300K (27 degrees C.) and 400K (127 degrees C.) for rapidly solidified permanent magnet alloy DyYFe₁₄B pursuant to the invention prepared under differing conditions of melt spinning wheel speed and annealing, demonstrating the flexibility in process parameters required to obtain excellent magnetic performance. Specimen X5-132-B (FIG. 1a) was spun at 22 m/s and annealed at 700 degrees C., and specimen X5-111C (FIG. 1b) was spun at 16 m/s and annealed at 850 degrees C. after being annealed at 700 degrees C. for 15 minutes.

FIG. 2 is a curve showing reduced temperature dependence of magnetization in an applied magnetic field of 1 Tesla for permanent magnet alloy Y_{1.25}Dy_{1.05}Fe_{13.6}COB pursuant to the invention melt spun at 22 m/s and after being annealed at 850 degrees C. for 15 minutes.

FIG. 3 shows magnetization-demagnetization curves at 27 degrees C. (300K), 200 degrees C. (473K), 250 degrees C. (523K), 270 degrees C. (543K), and 300 degrees C. (573K) for rapidly solidified permanent magnet alloy DyYFe₁₃CoB pursuant to the invention.

FIG. 4 shows magnetization-demagnetization curves at 27 degrees C. (300K), 77 degrees C. (350K), and 127 degrees C. (400K) for rapidly solidified permanent magnet alloy Y_{0.54}Dy_{0.54}Nd_{1.02}Fe_{13.5 CO}_{0.7}B pursuant to the invention.

FIG. 5 is an x-ray diffraction trace of He gas atomized powder (powder particle diameter greater than 32 microns and less than 38 microns) of YDyFe₁₄B alloy after annealing at 825 degrees C. for 2 hours, showing a full set of standard Bragg peaks for the MRE₂Fe₁₄B phase, which is the desired tetragonal crystalline phase pursuant to the invention.

FIGS. 6 and 7 illustrate the effect of the Y/Dy ratio on the magnetic properties of melt spun ribbons having the alloy compositions shown in the figures melt spun at 22 m/s and annealed at 750 degrees C. for 15 minutes. FIG. 6 shows the effect on the second quandrant loop at 300K (27 degrees C.) and FIG. 7 shows the effect on the second quandrant loop at 400K (127 degrees C.).

FIGS. 8, 9, 10, and 11 illustrate the effect of substitution of some Nd for the Y and Dy rare earth component for Y/Dy ratios of 1:1 to 2:1 on the energy product of melt spun ribbons having the alloy compositions shown in the figures melt spun at 22 m/s and annealed at 750 degrees C. for 15 minutes. FIGS. 8 and 10 show the effect on the second quandrant Hysteresis loop at 300K (27 degrees C.), and FIGS. 9 and 11 show the effect on the second quandrant Hysteresis loop at 400K (127 degees C).

FIG. 12 shows the effect of the addition of Co in melt spun ribbons having the alloy compositions shown in the figure and melt spun at 22 m/s and annealed at 750 degrees C. for 15 minutes on magnetization as a function of magnetic field at temperatures up to 300 C.

FIG. 13 shows the effect of addition of Co in melt spun ribbons having the alloy compositions shown in the figure melt spun at 22 m/s and annealed at 750 degrees C. for 15 minutes on Curie temperature.

FIGS. 14, 15, 16 and 17 show the effect of addition of Co in melt spun ribbons having the alloy compositions shown in the figure melt spun at 22 m/s and annealed at 750 degrees C. for 15 minutes on magnetization as a function of magnetic field at temperatures of 300K (FIGS. 14 and 16) and 400K (FIGS. 15 and 17).

FIG. 18 is a ternary diagram illustrating compositions in atomic percent of certain permanent magnet rare earth-iron-boron alloys pursuant to the invention that reside in the grey shaded area of the diagram defined by lines extending between points A, B, C, and D. LRE designates one or more of Nd and Pr light rare earth elements. HRE designates one or more of Tb, Dy, Ho and Er heavy rare earth elements. The circular, triangular, and square symbols represent permanent magnet alloys made pursuant to the invention.

### DETAILED DESCRIPTION OF THE INVENTION

The present invention provides a permanent magnet material that exhibits a reduced temperature dependence of magnetocrystalline anisotropy and saturation magnetization as compared to that of a permanent magnet based on Nd₂Fe₁₄B at temperatures above about 100 to about 300 degrees C. while retaining acceptable magnetic properties for a given use application.

The present invention provides in one embodiment a permanent magnet material at least a portion (by volume) of which includes a phase represented by MRE₂Tr₁₄X wherein MRE comprises Y and at least one other rare earth element, RE, with Y being present as 50% or more of the MRE on an atomic basis, Tr is a transition element preferably selected from the group consisting of Fe and Co, and X is an element selected from the group consisting of B and C. Preferably a majority by volume, and more preferably about 70% or more by volume, of the magnet material comprises the MRE₂Tr₁₄X phase. The RE element is selected from rare earth elements falling in Group IIIA of the Periodic Table and include Sc and the elements from atomic number 57 (La) through atomic number 71 (Lu). The RE element thus can be selected from the group consisting of Nd, Pr, La, Ce, Tb, Dy, Ho, Er, Eu, Sm, Gd, Pm, Tm, Yb, and Lu and combinations thereof.

A preferred embodiment of the invention provides a permanent magnet material at least a portion (by volume) of which includes a phase represented by MRE₂Tr₁₄X wherein MRE comprises Y and at least one other rare earth element and wherein Y plus at least one heavy rare earth element selected from the group consisting of Dy, Er, Ho, and Tb are present as 15% or more, preferably 50% or more, of the MRE on an atomic basis, Tr is a transition element, and X is an element selected from the group consisting of B and C. Such a permanent magnet material should have improved corrosion resistance compared to Nd₂Fe₁₄B based magnet material by virtue of the presence of the heavy rare earth element(s), which are less prone to oxidation than Nd, and the absence of the RE rich eutectic phase.

An illustrative permanent magnet material pursuant to a more preferred embodiment of the invention comprises a majority of MRE₂Fe₁₄B phase wherein MRE is Y and the heavy rare earth element, wherein the ratio of Y to heavy rare earth element is in the range of 0.5 to 3.0, preferably a ratio of 1 to 1, and wherein Y plus the heavy rare earth element is 15% or more on the MRE on an atomic basis. A further illustrative permanent magnet material pursuant to a more preferred embodiment of the invention comprises a majority of MRE₂Fe₁₄B phase where MRE is Y and Dy where the ratio of Y/Dy is in the range of 0.5 to 3.0.

The above-mentioned permanent magnet materials can be made from a permanent magnet alloy or composition comprising about 2 to about 20 atomic) % of Y, about 1 to about 20 atomic % of least one other rare earth element wherein the total rare earth content is about 3 to 21 atomic %, about 70 to about 96 atomic % Tr where Tr is a transition element preferably selected from the group consisting of Fe and Co, and about 0.3 to about 5 atomic % X where X is selected from the group consisting of B and C. Co may be substituted for some or all of the Fe to raise the Curie temperature of the material. Carbon (C) may be partially substituted for B in the X constituent.

The permanent magnet alloy or composition can be altered by the inclusion of additional elements which either substitute in the MRE₂Fe₁₄B phase in order to modify its intrinsic properties or which form secondary phases which control grain structure and/or modify the magnetic and/or corrosion properties of the final permanent magnet. For example, Al may be substituted for part of the transition element Tr. The optional inclusion of Si, Cu, Zn, Ga, Ti, Zr, Hf, V, Nb, Ta, Mo, and W, singly or in combination, in the alloy are examples of elements which control the grain boundaries and rapid solidification properties of the alloy. The addition of one or more of Zr, Hf, V, Nb, Ta, Mo, and W can be employed to form respective borides, carbides, and nitrides to control the grain boundaries and rapid solidification properties of the alloy as described for example in U.S. Pat. No. 5,486,240. When the permanent magnet material is to be used to make sintered magnets, the inclusion in the material of one or more sintering aids, such as a powder of the Dy-Fe eutectic, which is blended with the magnet alloy powder, is envisioned. The permanent magnet material may optionally include excess transition metal (Tr) and/or B to form relatively large fractions of soft magnetic Tr phase or soft magnetic Tr₃B phase together with the hard magnetic MRE₂Tr₁₄B phase in the permanent magnet material so long as useable coercivity is maintained. Such a modified permanent magnet material can find use in fabrication of exchange spring type of permanent magnets.

The permanent magnet material may optionally include excess Fe and MRE to form relatively large fractions of DyTr₂ or DyTr₃ phase together with the hard magnetic MRE₂Tr₁₄B phase in the permanent magnet material so long as useable magnetization is maintained. Such a modified permanent magnet material has high coercivity due to the presence of non-magnetic phases on the grain boundaries.

The major phase in a permanent magnet material or alloy pursuant to the invention decomposes peritectically on heating to MRE₂Tr₁₇ phase plus a liquid (e.g. liquid Tr with dissolved MRE and X), or melts congruently on heating, and exhibits a reduced temperature dependence of magnetocrystalline anisotropy and saturation magnetization above about 100 to about 300 degrees C. as compared that of a permanent magnet based on Nd₂Fe₁₄B as mentioned above.

A permanent magnet material pursuant to the invention can be made in the form of a rapidly solidified ribbon by conventional melt spinning, in the form of rapidly solidified pulverized particulates by conventional melt spinning of a ribbon followed by pulverization of the ribbon, in the form of atomized generally spherical powder particulates by melt atomization such as gas or centrifugal atomization, and in other rapidly solidified forms by processes used to produce rapidly solidified permanent magnet materials. Melt spinning is described in U.S. Pat. No. 4,496,395 and others, the teachings of which are incorporated herein by reference. Gas atomization is described in U.S. Pat. Nos. 5,242,508; 5,372,629; 5,811,187; and others, the teachings of which are incorporated herein by reference.

The rapidly solidified permanent magnet material or a magnet made from such particulates may optionally be heat treated at an elevated temperature for a time to form crystallites of the MRE₂Fe₁₄B phase in the material of desired crystallite size (grain size) to improve intrinsic coercivity, energy product, and other magnetic properties in the event the material does not already possess desired magnetic properties. For example, rapidly solidified permanent magnet ribbon discharged from a melt spinning wheel may or may not have desired magnetic properties depending on the parameters used during melting spinning. In the event the magnetic properties are less than desired in the melt spun condition, then the material can be annealed at an elevated temperature for a time to improve properties.

Particulates of the permanent magnet material can be conventionally pressed to a magnet shape and sintered to form an anisotropic permanent magnet. Alternately, particulates of the permanent magnet material can be mixed with a high temperature polymer binder, such polyphenyl-sulfide, and molded to a magnet shape to provide a bonded isotropic or anisotropic permanent magnet of reduced cost. Further, particulates of the permanent magnet material can be mixed with a metallic binder, such as aluminum or other metal or alloy that melts below about 1000 degrees C., to form a bonded isotropic or anisotropic permanent magnet of reduced cost. In the permanent magnet, the metallurgical grain size of the MRE₂Tr₁₄X phase is between 10 nm and 30 microns.

The following Examples are offered for purposes of further illustrating the invention without limiting it. Alloys pursuant to the invention set forth in Table 1 were prepared wherein the alloys in Table 1 are represented by relative atomic proportions or compositions:

TABLE 1

| Sample ID | Composition |
|---|---|
| X5-111, | YDyFe₁₄B |
| X5-132 | |
| X5-199 | |
| BT-4-180 | |
| X5-201 | YDyFe₁₃CoB |
| X5-155 | YDyFe₁₂Co₂B |
| X5-147 | Y_{1.2}Dy_{0.8}Fe₁₀Co₄B |
| MWF42, | Y_{1.2}Dy_{0.8}Fe₁₄B |
| X5-153, | |
| X5-151 | |
| MWF41 | Y_{1.15}Dy_{1.15}Fe_{14.6}B |
| MWF43 | Y_{1.35}Dy_{0.95}Fe_{14.6}B |
| X5-171 | Y_{1.2}Dy_{0.80}Fe_{13.72}Co_{0.28}B |
| X5-169 | Y_{1.4}Dy_{0.6}Fe₁₄B |
| MWF34 | Y₂Dy₂Fe₁₄B |
| BJZ2-12 | Y_{.54}Dy_{.54}Nd_{1.02}Fe_{13.5}Co_{.7}B |

The alloys were prepared as respective button shaped ingots by arc-melting the constituent elements in an argon atmosphere on a water-cooled copper hearth. Each ingot was turned and remelted several times on the hearth to insure chemical homogeneity.

Each arc melted ingot sample was then induction melted and melt spun on a copper wheel at room temperature in ⅓ atmosphere helium to produce a rapidly solidified ribbon specimen. The surface velocity of the copper wheel used in the tests is set forth in Table 2 in the column labeled “wheel velocity” where (m/s) represents meters/second wheel speed.

The sample labeled “BT-4-180” with the nominal composition of YDyFe₁₄B was produced by He gas atomization, resulting in fine, spherical powder particles. The charge materials for the atomizer consisted of, in weight A, electrolytic Fe, ferroboron (Fe-19.1 weight % B), Y-16 weight 9 Fe, and Dy-16 weight O Fe, in proper amounts to produce the intended alloy. The total charge weight of 4000 grams was heated under an Ar atmosphere in an alumina crucible to melt and homogenize the alloy prior to pouring at a superheat of about 400 degrees C. in a high pressure gas atomization system. The melt stream was atomized into the spray chamber with He gas supplied at a pressure of 5.52 MPa, where an extra He gas flow (top plate halo) was added for additional convective cooling. The resulting atomized spray passed through a supplemental reactive gas (N₂) halo flow (from the chamber wall) and, further downstream, a hydrocarbon gas source (at the entrance to the chamber elbow-section), to incorporate a passivating surface film on the resulting powders, in a manner consistent with the teachings of U.S. Pat. No. 5,811,187. The collected powder, with a size range from about 1 to 100 microns, was size classified for subsequent characterization.

TABLE 2
Melt spinning and heat treatment conditions for selected samples>

| | | Wheel | Heat |
|---|---|---|---|
| | | Velocity | Treatment |
| Sample ID | Composition | (m/s) | 15 min |
| X5-111 | YDyFe₁₄B | 16 | as spun |
| X5-111A | YDyFe₁₄B | 16 | 650° C. |
| X5-111B | YDyFe₁₄B | 16 | 750° C. |
| X5-111C | YDyFe₁₄B | 16 | 850° C. |
| X5-132 | YDyFe₁₄B | 22 | as spun |
| X5-132A | YDyFe₁₄B | 22 | 650° C. |
| X5-132B | YDyFe₁₄B | 22 | 700° C. |
| X5-132C | YDyFe₁₄B | 22 | 750° C. |
| X5-199 | YDyFe₁₄B | 16(Ar) | as spun |
| X5-199A | YDyFe₁₄B | 16(Ar) | 650° C. |
| X5-199B | YDyFe₁₄B | 16(Ar) | 750° C. |
| X5-199C | YDyFe₁₄B | 16(Ar) | 850° C. |
| X5-201 | YDyFe₁₃CoB | 22 | as spun |
| X5-201A | YDyFe₁₃CoB | 22 | 650° C. |
| XS-201B | YDyFe₁₃CoB | 22 | 750° C. |
| X5-201C | YDyFe₁₃CoB | 22 | 850° C. |
| X5-155 | YDyFe₁₂Co₂B | 22 | as spun |
| X5-155A | YDyFe₁₂Co₂B | 22 | 650° C. |
| X5-155B | YDyFe₁₂Co₂B | 22 | 750° C. |
| X5-155C | YDyFe₁₂Co₂B | 22 | 850° C. |
| X5-147 | Y_{1.2}Dy_{0.8}Fe₁₀Co₄B | 22 | as spun |
| X5-147A | Y_{1.2}Dy_{0.8}Fe₁₀Co₄B | 22 | 650° C. |
| X5-147B | Y_{1.2}Dy_{0.8}Fe₁₀Co₄B | 22 | 750° C. |
| MWF42 | Y_{1.2}Dy_{0.8}Fe₁₄B | 16 | as spun |
| MWF42A | Y_{1.2}Dy_{0.8}Fe₁₄B | 16 | 650° C. |
| X5-153 | Y_{1.2}Dy_{0.8}Fe₁₄B | 22 | as spun |
| X5-153A | Y_{1.2}Dy_{0.8}Fe₁₄B | 22 | 650° C. |
| X5-153B | Y_{1.2}Dy_{0.8}Fe₁₄B | 22 | 750° C. |
| X5-151 | Y_{1.2}Dy_{0.8}Fe₁₄ | 22 | as spun |
| X5-151A | Y_{1.2}Dy_{0.8}Fe₁₄ | 22 | 650° C. |
| MWF41 | Y_{1.15}Dy_{1.15}Fe_{14.6}B | 22 | as spun |
| MWF41A | Y_{1.15}Dy_{1.15}Fe_{14.6}B | 22 | 650° C. |
| MWF43 | Y_{1.35}Dy_{0.95}Fe_{14.6}B | 22 | as spun |
| MWF43A | Y_{1.35}Dy_{0.95}Fe_{14.6}B | 22 | 650° C. |
| X5-171 | Y_{1.2}Dy_{0.80}Fe_{13.72}Co_{0.28}B | 22 | as spun |
| X5-171A | Y_{1.2}Dy_{0.80}Fe_{13.72}Co_{0.28}B | 22 | 650° C. |
| X5-169 | Y_{1.4}Dy_{0.6}Fe₁₄B | 22 | as spun |
| X5-169A | Y_{1.4}Dy_{0.6}Fe₁₄B | 22 | 650° C. |
| MWF34 | Y₂Dy₂Fe₁₄B | 22 | as spun |
| MWF34A | Y₂Dy₂Fe₁₄B | 22 | 650° C. |
| MWF34B | Y₂Dy₂Fe₁₄B | 22 | 750° C. |
| MWF34C | Y₂Dy₂Fe₁₄B | 22 | 850° C. |
| BJZ2-12 | Y_{.54}Dy_{.54}Nd_{1.02}Fe_{13.5}Co_{.7}B | 22 | 650° C. |
| BT-4-180 | YDyFe₁₄B | Gas | |
| | | atomized | |

The ribbon specimens were tested for magnetic properties in the as-spun condition and after annealing at different temperatures and times to form crystallites of the MRE₂Fe₁₄B phase in the material of desired crystallite size (grain size) to improve intrinsic coercivity, energy product, and other magnetic properties. The heat treatment temperatures are set forth in Table 2. Unless otherwise indicated, the heat treatment time was 15 minutes. The heat treatment of the ribbon specimens was conducted in a sealed quartz ampoule in an argon atmosphere. Samples were inserted into a preheated furnace, and the ampoules were air quenched after annealing. Magnetic measurements were made in a Quantum Design SQUID magnetometer at 300K and 400K. Ribbon specimens were mounted with the ribbon length parallel to the field direction. No correction was made for demagnetizing factors. High temperature (greater than 400K) measurements were made in a vibrating sample magnetometer. For the high temperature measurements, the samples were sealed in quartz ampoules to avoid oxidation.

In Table 3, the magnetic properties of specimens that were measured at both 300K (27 degrees C.) and 400K (127 degrees C.) are reported. The magnetization (4πM) of the specimens measured at a field strength of 4.8 Teslas is reported as an indication of the saturation magnetization (Mₛ). The energy product (BHₘₐₓ), the coercivity (H_{ci}), and the remanent magnetization (Bᵣ where Bᵣ=Mᵣ) are reported for both temperatures. Table 4 sets forth the temperature coefficients for saturation magnetization (4πM), energy product (BHₘₐₓ), the coercivity (H_{ci}), and the remanent magnetization (Mᵣ) for certain specimens. Table 5 compares the temperature coefficients for the coercivity (H_{ci}) and the remanent magnetization (Mᵣ) to those of commercial powders made by Magneguench International, Inc. The commercial powders are identified by the manufacturer's MQP product designation and the values are from the product literature.

TABLE 3
Magnetic properties for selected samples at 300K
(27° C.) and 400K (127° C.)

| | | at 4.8T | | 300K | | at 4.8T | | 400K | |
|---|---|---|---|---|---|---|---|---|---|
| | | 4_{π}Mₛ | (BH)ₘₐₓ | Hc | Br | 4_{π}Mₛ | (BH)ₘₐₓ | Hc | Br |
| | | (kG) | (MGOe) | (kOe) | (kG) | (kG) | (MGOe) | (kOe) | (kG |
| X5-111C | YDyFe₁₄B | 9.1 | 7.3 | 12 | 5.83 | 9.1 | 5.6 | 7.5 | 5.36 |
| X5-132A | YDyFe₁₄B | 9.3 | 7.1 | 14 | 6.04 | 9.2 | 5.9 | 9 | 5.59 |
| X5-132B | YDyFe₁₄B | 9.1 | 8.1 | 15 | 6.07 | 9.1 | 6.9 | 10 | 5.65 |
| X5-132C | YDyFe₁₄B | 9 | 7.8 | 15 | 5.96 | 9.1 | 6.7 | 10 | 5.59 |
| X5-199C | YDyFe₁₄B | 9.24 | 4.6 | 9 | 5.5 | 9.32 | 3.4 | 5 | 5.1 |
| X5-201A | YDyFe₁₃CoB | 9.77 | 7.5 | 12 | 6.3 | 10.1 | 6.5 | 8 | 6.1 |
| X5-155B | YDyFe₁₂Co₂B | 9.34 | 7.89 | 13 | 6.17 | 9.84 | 7.34 | 8 | 6.1 |
| X5-155C | YDyFe₁₂Co₂B | 9.34 | 7.29 | 11 | 6.02 | 9.68 | 6.45 | 7 | 5.81 |
| X5-147B | Y_{1.2}Dy_{0.8}Fe₁₀Co₄B | 10.6 | 6.52 | 7 | 6.55 | 11.2 | 4.85 | 5 | 6.45 |
| X5-153 | Y_{1.2}Dy_{0.8}Fe₁₄B | 10.4 | 10.5 | 13 | 6.92 | 10 | 8.2 | 9 | 6.33 |
| X5-153A | Y_{1.2}Dy_{0.8}Fe₁₄B | 10 | 9 | 12 | 6.57 | | | | |
| X5-153B | Y_{1.2}Dy_{0.8}Fe₁₄B | 10.5 | 9.97 | 12 | 6.8 | 10.4 | 7.84 | 8 | 6.09 |
| X5-151A | Y_{1.2}Dy_{0.8}Fe₁₄ | 7.54 | 6.06 | 24 | 5.17 | 7.72 | 5.35 | 16 | 4.92 |
| MWF41A | Y_{1.15}Dy_{1.15}Fe_{14.6}B | 8.28 | 6.8 | 20 | 5.55 | 8.44 | 5.82 | 14 | 5.22 |
| MWF43A | Y_{1.35}Dy_{0.95}Fe_{14.6}B | 8.99 | 7.57 | 17 | 5.89 | 8.85 | 6.08 | 12 | 5.36 |
| X5-171A | Y_{1.2}Dy_{0.80}Fe_{13.72}Co_{0.28}B | 9.52 | 8.44 | 15 | 6.3 | 8.82 | 6.58 | 10 | 5.62 |
| X5-169A | Y_{1.4}Dy_{0.6}Fe₁₄B | 11.3 | 10.2 | 9 | 7.2 | 10.6 | 7.24 | 6 | 6.35 |
| BJZ2-12 | Y_{.54}Dy_{.54}Nd_{1.02}Fe_{13.5}Co_{.7}B | 11.5 | 11.6 | 12 | 7.6 | 11.3 | 9.1 | 8 | 6.9 |

TABLE 4
Temperature coefficient between 300K (27° C.) and 400K
(127° C.) for selected samples

| | | Temperature coefficient %/C. | | | |
|---|---|---|---|---|---|
| | | Based on 300K and 400K data | | | |
| | | 4_{π}Mₛ | | | |
| | | (kG) | (MGOe) | H_{ci} | 4_{π}M_{r.} |
| X5-111C | YDyFe₁₄B | 0 | −0.23288 | −0.375 | −0.08062 |
| X5-132A | YDyFe₁₄B | −0.01 | −0.17 | −0.36 | −0.07 |
| X5-132B | YDyFe₁₄B | 0 | −0.15 | −0.33 | −0.07 |
| X5-132C | YDyFe₁₄B | 0.01 | −0.14 | −0.33 | −0.06 |
| X5-199C | YDyFe₁₄B | 0.01 | −0.26 | −0.44 | −0.07 |
| X5-201A | YDyFe₁₃CoB | 0.03 | −0.13 | −0.33 | −0.03 |
| X5-155B | YDyFe₁₂Co₂B | 0.05 | −0.07 | −0.38 | −0.01 |
| X5-155C | YDyFe₁₂Co₂B | 0.04 | −0.12 | −0.36 | −0.03 |
| X5-147B | Y_{1.2}Dy_{0.8}Fe₁₀Co₄B | 0.06 | −0.26 | −0.29 | −0.02 |
| X5-153 | Y_{1.2}Dy_{0.8}Fe₁₄B | −0.04 | −0.22 | −0.31 | −0.10 |
| X5-153A | Y_{1.2}Dy_{0.8}Fe₁₄B | | | | |
| X5-153B | Y_{1.2}Dy_{0.8}Fe₁₄B | −0.01 | −0.21 | −0.33 | −0.10 |
| X5-151A | Y_{1.2}Dy_{0.8}Fe₁₄ | 0.024 | −0.12 | −0.33 | −0.05 |
| MWF41A | Y_{1.15}Dy_{1.15}Fe_{14.6}B | 0.02 | −0.14 | −0.3 | −0.06 |
| MWF43A | Y_{1.35}Dy_{0.95}Fe_{14.6}B | −0.02 | −0.20 | −0.29 | −0.09 |
| X5-171A | Y_{1.2}Dy_{0.8}Fe_{13.72}Co_{0.28}B | −0.07 | −0.22 | −0.33 | −0.11 |
| X5-169A | Y_{1.4}Dy_{0.6}Fe₁₄B | −0.07 | −0.29 | −0.33 | −0.12 |
| BJZ2-12 | Y_{.54}Dy_{.54}Nd_{1.02}Fe_{13.5}Co_{.7}B | | −0.21 | −0.33 | −0.08 |

TABLE 5
Comparison of the temperature coefficients of the coercivity and
remanence for non optimized compositions according to the invention
with commercial powders. The coefficients for the invention are
calculated between 27° C. and 127° C. while the commercial
powders are evaluated over the lower range 27° C. and 100° C.

| | | H_{ci} | M_{r.} |
|---|---|---|---|
| | | %/° C. | %/° C. |
| X5-111C | YDyFe₁₄B | −0.38 | −0.08 |
| X5-132A | YDyFe₁₄B | −0.36 | −0.07 |
| X5-132B | YDyFe₁₄B | −0.33 | −0.07 |
| X5-132C | YDyFe₁₄B | −0.33 | −0.06 |
| X5-199C | YDyFe₁₄B | −0.44 | −0.07 |
| X5-201A | YDyFe₁₃CoB | −0.33 | −0.03 |
| X5-155B | YDyFe₁₂Co₂B | −0.38 | −0.01 |
| X5-155C | YDyFe₁₂Co₂B | −0.36 | −0.03 |
| X5-147B | Y_{1.2}Dy_{0.8}Fe₁₀Co₄B | −0.29 | −0.02 |
| X5-153 | Y_{1.2}Dy_{0.8}Fe₁₄B | −0.31 | −0.10 |
| X5-153A | Y_{1.2}Dy_{0.8}Fe₁₄B | | |
| X5-153B | Y_{1.2}Dy_{0.8}Fe₁₄B | −0.33 | −0.10 |
| X5-151A | Y_{1.2}Dy_{0.8}Fe₁₄ | −0.33 | −0.05 |
| MWF41A | Y_{1.15}Dy_{1.15}Fe_{14.6}B | −0.3 | −0.06 |
| MWF43A | Y_{1.35}Dy_{0.95}Fe_{14.6}B | −0.29 | −0.09 |
| X5-171A | Y_{1.2}Dy_{0.80}Fe_{13.72}Co_{0.28}B | −0.33 | −0.11 |
| X5-169A | Y_{1.4}Dy_{0.6}Fe₁₄B | −0.33 | −0.12 |
| BJZ2-12 | Y_{.54}Dy_{.54}Nd_{1.02}Fe_{13.5}Co_{.7}B | −0.33 | −0.08 |
| MQP-A | | −0.4 | −0.12 |
| MQP-B | | −0.4 | −0.11 |
| MQP-B+ | | −0.4 | −0.11 |
| MQP-C | | −0.4 | −0.07 |
| MQP-D | | −0.4 | −0.08 |
| MQP-O | | −0.4 | −0.13 |
| MQP-14-12 | | −0.4 | −0.13 |
| MQP-15-7 | | −0.4 | −0.11 |
| MQP-16-7 | | −0.4 | −0.08 |
| MQP_13-9 | | −0.4 | −0.12 |
| MQP-S-11-9 | | −0.4 | −0.13 |

The results presented in Tables 2 and 3 show that materials according to the invention may be prepared over a broad range of compositions under a variety of processing conditions. The microstructure of these materials requires relatively high temperature annealing to effect changes in the microstructure as reflected in the magnetic properties. This indicates that the optimal microstructure is quite stable for elevated temperature operation. Table 3 shows that, as a group, the materials according to the invention demonstrate low thermal coefficients of the magnetic properties. Table 4 demonstrates that even materials according to the invention that have not received the optimum processing nevertheless match the thermal coefficients of the best available materials, while more completely optimized materials of the invention have significantly improved thermal performance.

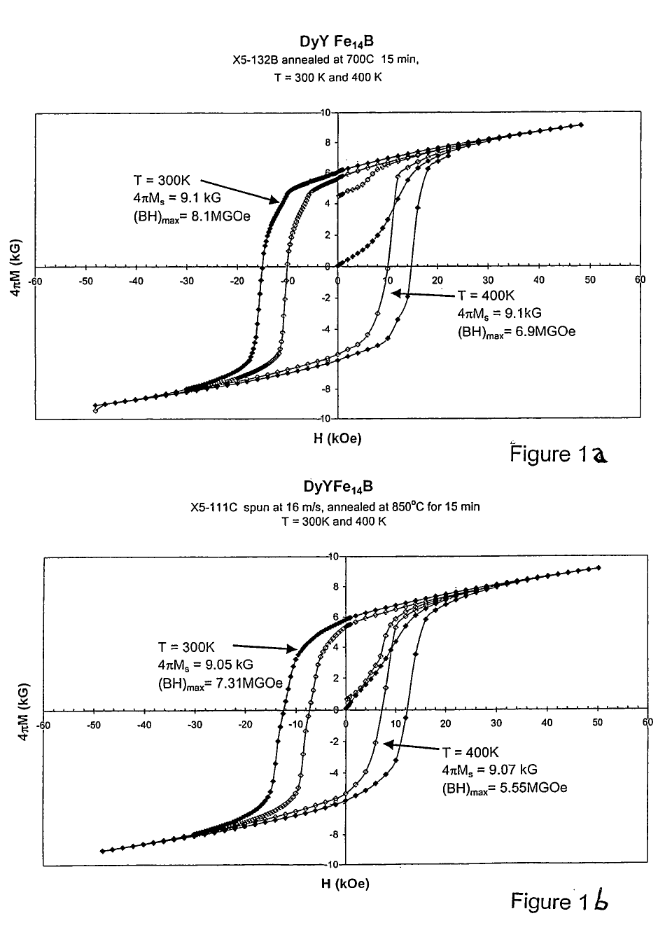

FIG. 1a shows magnetization-demagnetization curves at 300K and 400K for permanent magnet material pursuant to the invention including greater than 95 volume % s of DyYFe₁₄B phase after being annealed at 700 degrees C. for 15 minutes. Magnetization and energy product values for the material are shown in FIG. 1a.

FIG. 1b shows magnetization-demagnetization curves at 300K and 400K for permanent magnet material pursuant to the invention including 95 volume O or greater of DyYFe₁₄B phase melt spun at 16 m/s and after being annealed at 850 degrees C. for 15 minutes. Magnetization and energy product values for the material are shown in FIG. 1b.

FIGS. 1a and 1b illustrate the reduced temperature dependence of magnetization of the permanent magnet material pursuant to the invention including the DyYFe₁₄B phase for two different melt spinning wheel velocities and heat treatments. The high annealing temperatures used indicate that the microstructure of the magnets is extremely stable. The fact that the same composition can be processed at significantly different wheel speeds and annealing temperatures indicates that there is a broad window of process parameters that will yield high quality magnet materials so that high yields of material may be expected in industrial processing.

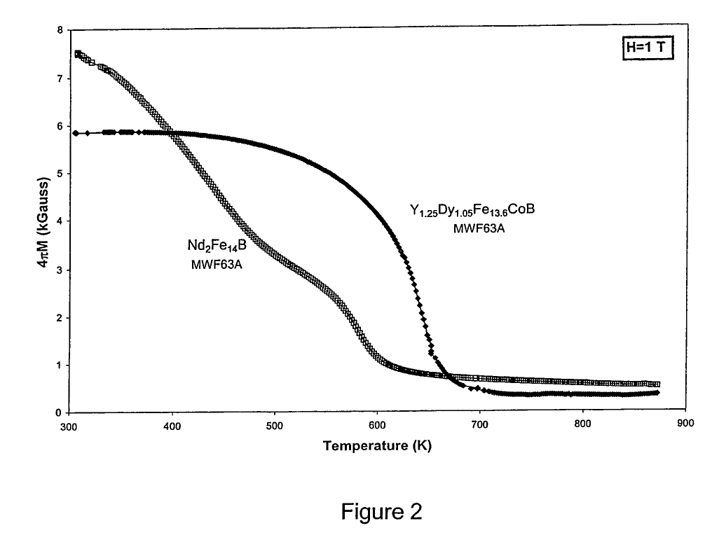

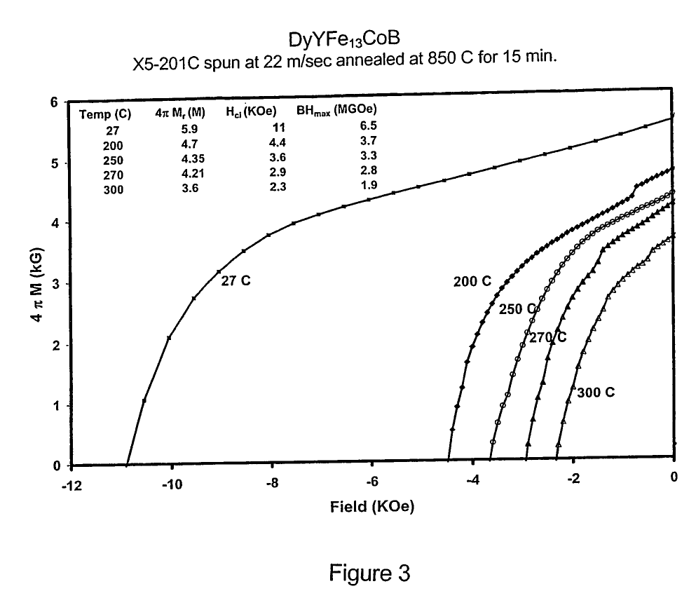

FIG. 2 is a curve showing temperature dependence of magnetization in an applied magnetic field of 1 Tesla for permanent magnet alloy material pursuant to the invention including 85% by volume of DyYFe₁₃CoB phase. The material was melt spun at 22 m/s and then annealed at 850 degrees C. for 15 minutes. Included in this figure is the temperature dependence of a Nd₂Fe₁₄B sample prepared by melt spinning at 22r m/s and annealed at 650 degrees C. for 15 minutes. The reduced temperature dependence of the material of this invention results in superior magnetic properties above 400K and allows this material to be used up to at least 600K. FIG. 3 gives a summary of the magnetization-demagnetization curves at 27 degrees C. (300K), 200 degrees C. (473K), 250 degrees C. (523K), 270 degrees C. (543K), and 300 degrees C. (573K) for a ribbon sample of rapidly solidified permanent magnet DyYFe₁₃CoB alloy. This example illustrates the diminished decay of the magnetic energy product (MGOe) of a representative alloy of the invention, in this case containing 100% of the stoichiometric DyYFe₁₃CoB phase. The material was spun at 22 m/s and annealed at 850 degrees C. for 15 minutes. Consistent with the data presented in FIG. 2, the magnetic property summary in FIG. 3 again shows the clear advantage of these alloys over Nd₂Fe₁₄B for high temperature magnetic performance, where a substantial energy product is exhibited above 200 degrees C. The energy product at 200 degrees C. is approximately twice as high as ferrite magnets, which are the competitive magnetic material for electric drive motors, a key application for high temperature permanent magnets.

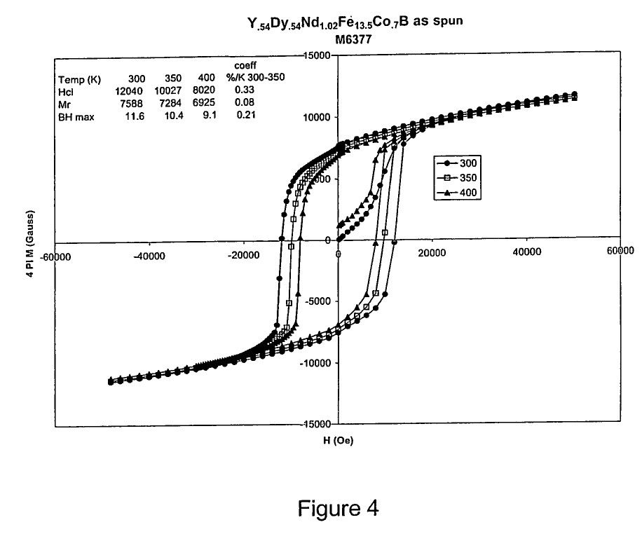

FIG. 4 illustrates the reduced temperature dependence of magnetization of the permanent magnet material Y_{0.54}Dy_{0.54}Nd_{1.02}Fe_{13.5}Co_{0.7}B which pursuant to the invention includes the DyYFe₁₄B phase where Y and Dy have been partially substituted by Nd and Fe has been partially substituted by Co. In addition, the composition is such that there is a minor phase fraction of a REFe₂ phase. The material exhibits exceptionally low temperature coefficients for the magnetic properties and a highly favorable loop shape which is retained above 100 degrees C.

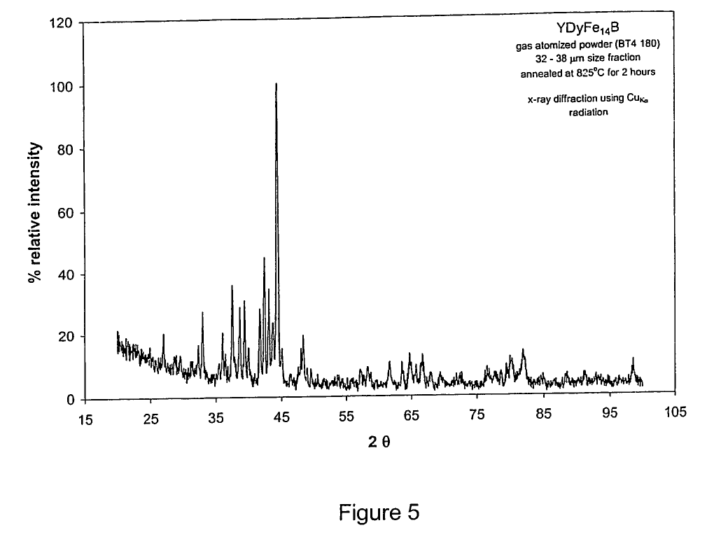

FIG. 5 presents an x-ray diffraction trace of He gas atomized powder (diameter greater than 32 microns and less than 38 microns) of YDyFe₁₄B alloy after annealing at 825 degrees C. for 2 hours, showing a full set of standard Bragg peaks for the MRE₂Fe₁₄B phase. The initial solidification product phases included the MRE₂Fe₁₇ phase and a significant amorphous phase fraction. The MRE₂Fe₁₄B phase in FIG. 5 resulted from complete conversion to the desired tetragonal crystalline phase during the high temperature anneal, essential to development of desirable magnetic properties. The spherical atomized powder shape is considered ideal for injection molded bonded magnets, the preferred manufacturing method for many low cost, high-volume applications, including high torque electric drive motors for automobiles.

The combination of Y and Dy in certain embodiments of the permanent magent alloys of the invention results in very good temperature dependencies of the hysteresis loops and excellent rapid solidification characteristics due to the fact that there is no low melting liquid in equilibrium with the hard magnetic phase. However, the energy product of such Y-Dy containing permanent magnet alloys can be considerably lower than that of Nd-based permanent magnet alloys. The energy product can be improved in practice of the invention by the susbtitution of some the Y-Dy rare earth component with Nd and/or Pr.

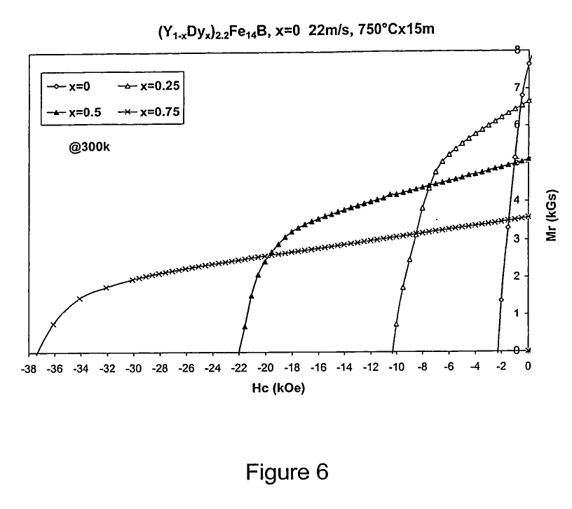

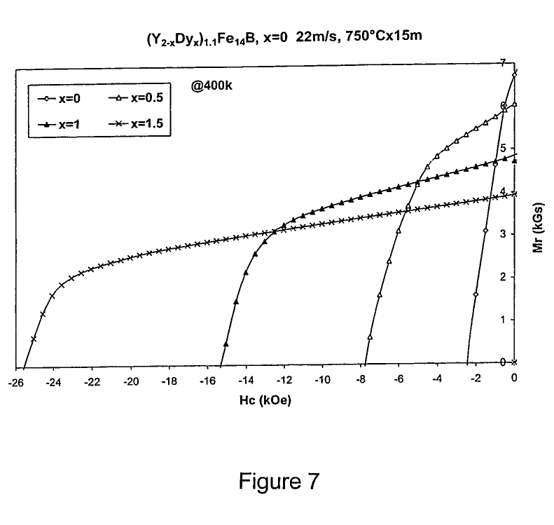

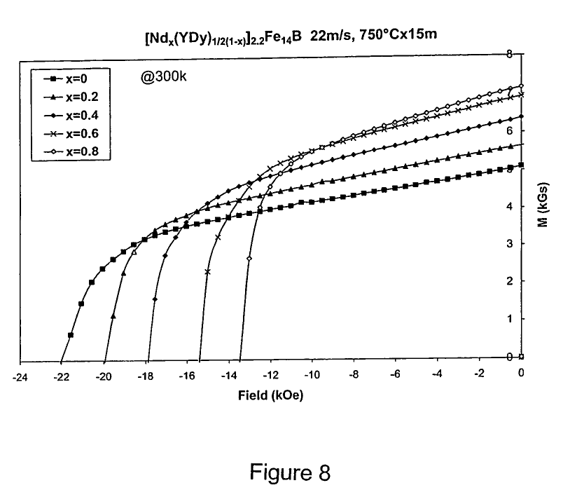

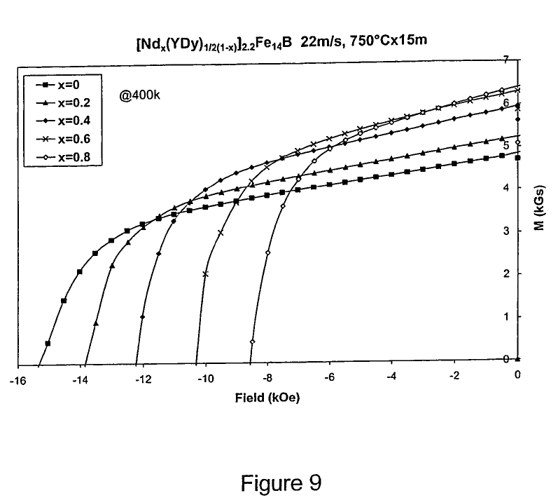

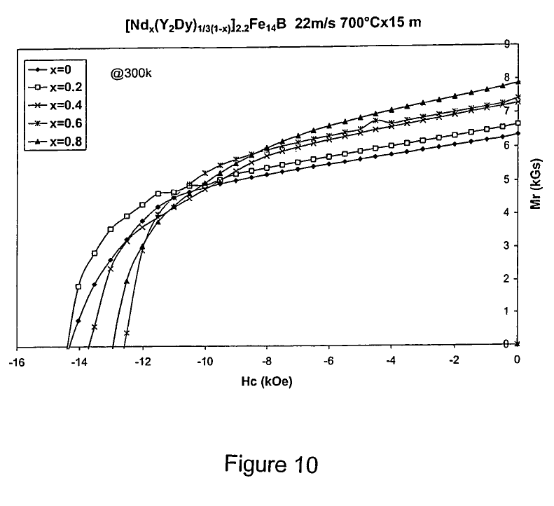

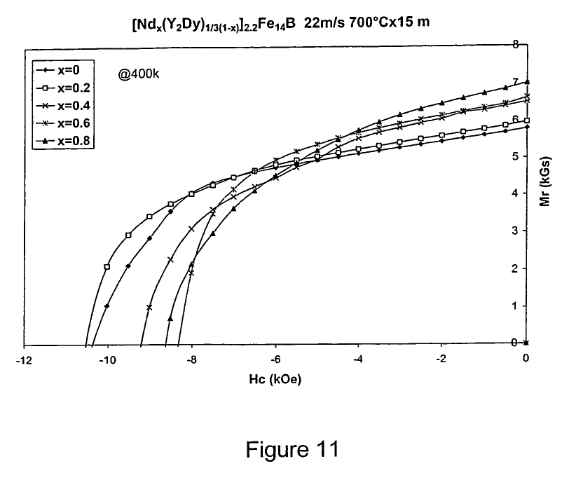

For example, referring to FIGS. 6 and 7, the effect of the Y/Dy ratio on the magnetic properties (energy product) of melt spun ribbons having the alloy compositions shown in the figures melt spun at 22 m/s and annealed at 750 degrees C. for 15 minutes is shown. FIG. 6 involves (Y₁₋ₓDyₓ)_{2.2}Fe₁₄B alloys where x is 0, 0.25, 0.50, and 0.75 and shows the ratio effect on the second quandrant Hysteresis loop at 300K (27 degrees C.). FIG. 7 involves (Y₂₋ₓDyₓ)_{1.1}Fe₁₄B alloys where x is 0, 0.50, 1.0 and 1.S and shows the effect on the second quandrant Hysteresis loop at 400K (127 degrees C.). FIGS. 8, 9, 10, and 11 illustrate the beneficial effect on energy product of substitution of some Nd for the Y and Dy rare earth component of melt spun ribbons having the alloy compositions shown in the figures melt (Y/Dy ratios of 1:1 to 2:1) spun at 22 m/s and annealed at 750 degrees C. (FIGS. 8 and 9)or 700 degrees C. (FIGS. 10 and 11) for 15 minutes. FIGS. 8 and 9 show this effect for [Ndₓ(YDy)_{1/2}(₁₋ₓ)]_{2.2}Fe₁₄B alloys where x is 0, 0.2, 0.4, 0.6 and 0.8 at 300K and 400K, respectively. FIGS. 10 and 11 show this effect for [Ndₓ(Y₂Dy)_{1/3(1-x)}]_{2.2}Fe₁₄B alloys where x is 0, 0.2, 0.4, 0.6 and 0.8 at 300K and 400K, respectively.

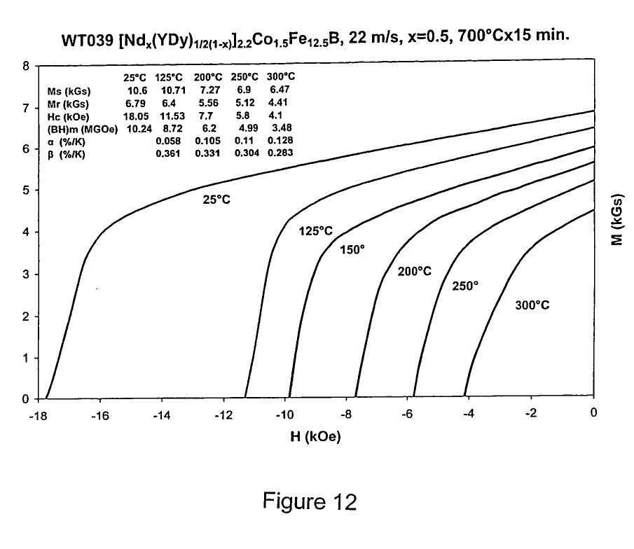

The ultimate high temperature performance of permanent magnet alloys is limited by the Curie temperature. The Curie tmeprature can be increased by the addition of Co but, for Nd-based permanent magnet alloys, siginificant Co additions result in an unacceptably large decrease in the coercivity. FIG. 12 illustrates for a particular illustrative permanent magnet alloy of the invention offered for purposes of illustration and not limitation that in practice of the invention the Curie temperature can be increased by substituting Co for Fe. FIG. 12 illustrates this effect for the [Ndₓ(YD_{y})_{1/2(1-x)}]_{2.2}Co_{1.5}Fe_{12.5}B alloy where x is 0.5 and where Nd is substituted for some of the Y-Dy rare earth component of the alloy and melt spun at 22 m/s followed by annealing at 700 degees C for 15 minutes. FIG. 12 shows magnetization as a function of magnetic field at temperatues up to 300 degrees C. and that useful magnetic properties are achieved up to 300 degrees C.

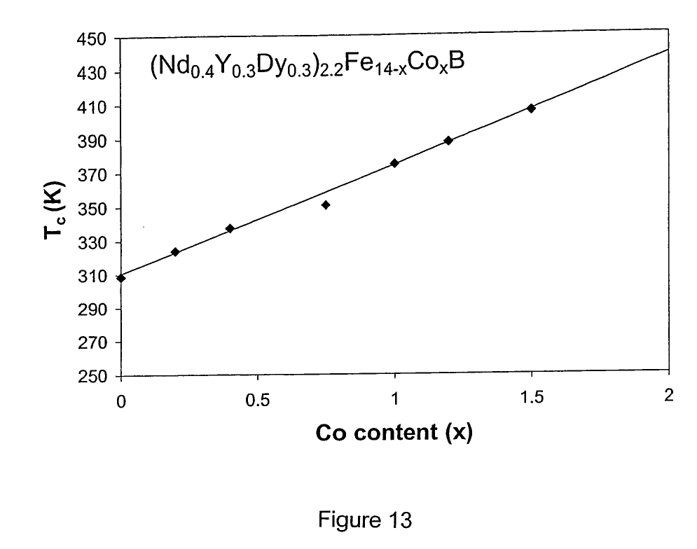

FIG. 13 shows the beneficial effect of addition of Co on Curie temperature in melt spun ribbons having the Nd_{0.4}Y_{0.3}Dy_{0.3}Fe₁₄₋ₓCoₓB alloy composition, where values of x are shown on the horizontal axis of the figure. The Curie temperature was measured on samples melt spun at 22 m/s and annealed at 750 degrees C. for 15 minutes. While there is some non-systematic variation, the reduction in coercivity due to the Co additions is considerably less than that in Bd-based permanent magnets. This beneficial effect allows the Curie temperature to be increased so that operation of the permanent magnet alloys of the invention at 300 degrees C. is possible.

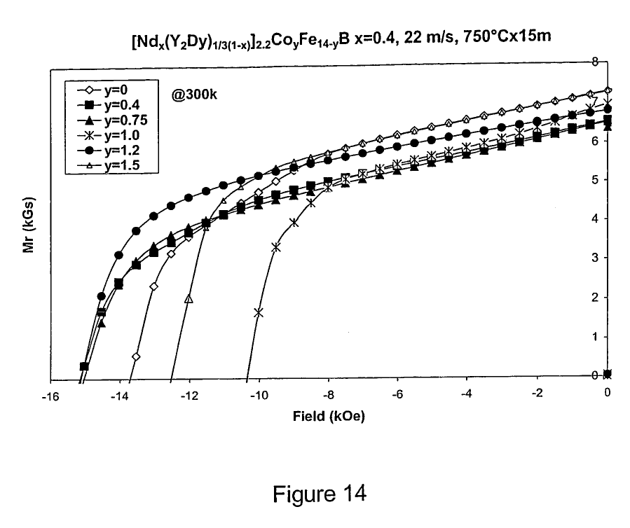

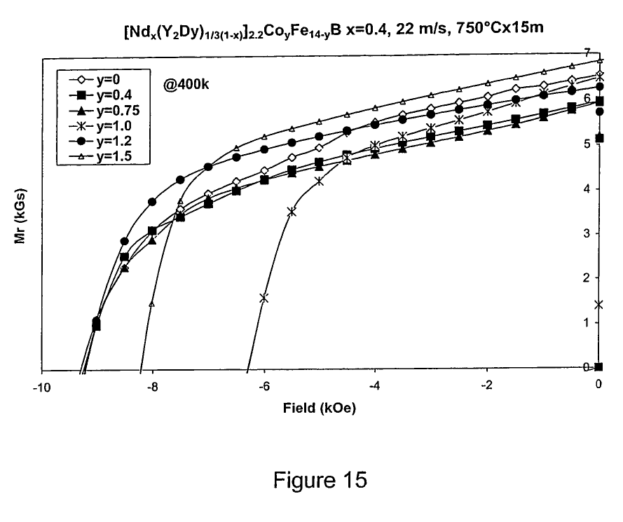

FIGS. 14 and 15 show the beneficial effect on magnetization as function of magnetic field of the addition of Co to melt spun ribbons for [Ndₓ(Y₂Dy)_{1/3(1-x)}]_{2.2}Co_{y}Fe_{14-y}B alloys where x is 0.4 at 300K and 400K, respectively. The Co concentration was varied to provide a value of y=0, 0.4, 0.75, 1.0, 1.2, and 1.5. The alloys were melt spun at 22 m/s and annealed at 750 degrees C. for 15 minutes.

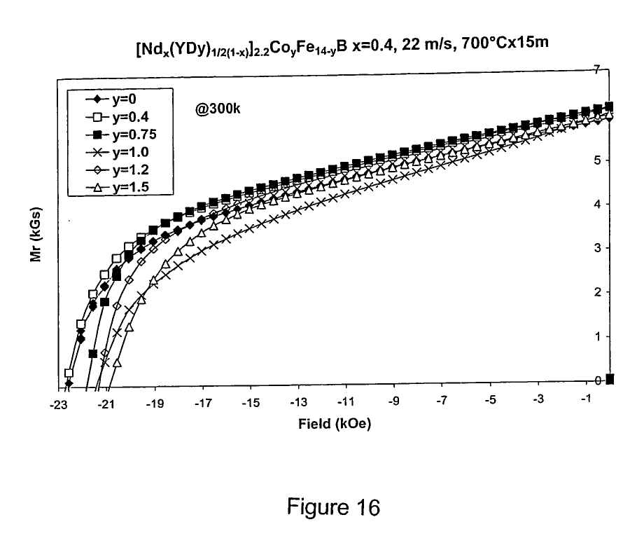

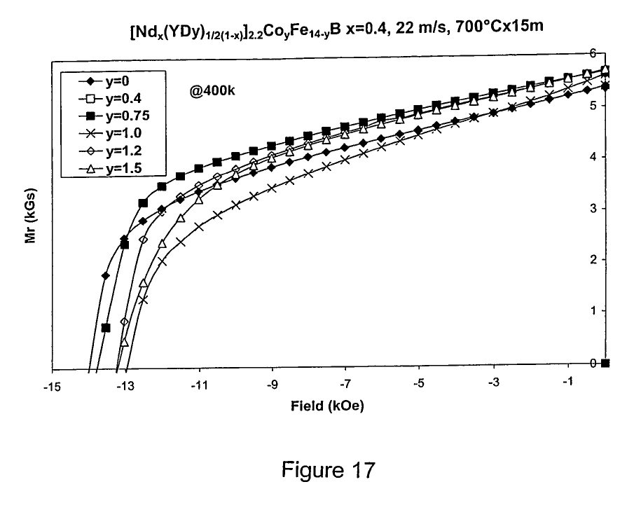

FIGS. 16 and 17 show the beneficial effect on magnetization as function of magnetic field of the addition of Co in melt spun ribbons for [Ndₓ(YD_{y})_{1/2(1-x)}]_{2..2}Co_{y}Fe_{14-y}B alloys where x is 0.4 at 300K and 400K, respectively. The Co concentration was varied to provide a value of y=0, 0.4, 0.75, 1.0, 1.2, and 1.5. The alloys were melt spun at 22 m/s and annealed at 750 degrees C. for 15 minutes.

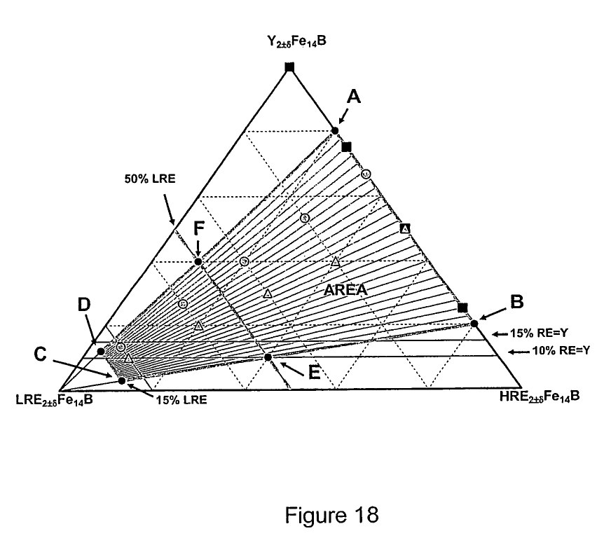

Referring to FIG. 18, a ternary diagram is shown illustrating certain rare earth-iron-boron permanent magnet alloys pursuant to illustrative embodiments of the invention. In FIG. 18, LRE designates one or more of Nd and/or Pr relatively light rare earth element(s). HRE designates one or more of Tb, Dy, Ho and/or Er relatively heavy rare earth element (s). The illustrative rare earth-iron-boron permanent magnet alloys pursuant to the invention reside in the shaded area AREA defined by a line extending between point A to point B, a line between point B to point C, a line between point C to point D, and a line extending from point D to point A. Certain more preferred rare earth-iron- boron permanent magnet alloys pursuant to illustrative embodiments of the invention reside in the shaded area AREA defined by a line extending between point A to point B, a line between point B to point E, a line between point E to point F, and a line extending from point F to point A. In FIG. 18, LRE designates one or more of Nd and/or Pr relatively light rarearth element(s). HRE designates one or more of Tb, Dy, Ho and/or Er relatively heavy rare earth element(s). The circular, triangular, and square symbols represent permanent magnet alloys made pursuant to the invention.

While the present invention has been described in terms of certain illustrative embodiments thereof, it is not intended to be limited thereto but rather only to the extent set forth in the following claims.

1. A permanent magnet material at least a portion of which includes a phase represented by MRE₂Tr₁₄X wherein MRE comprises Y and at least one other rare earth element with Y being present as 15% or more of the MRE on an atomic basis, Tr is a transition element, and X is an element selected from the group consisting of B and C.

2. The material of claim 1 wherein Y is present as 50% or more of the MRE on an atomic basis.

2A. (canceled)

3. The material of claim 1 wherein a majority by volume of said material comprises said phase.

4. The material of claim 1 wherein the transition element is selected from the group consisting of Fe and Co.

5. The material of claim 1 in which the MRE₂Tr₁₄X phase decomposes peritectically on heating to MRE₂Tr₁₇ phase plus a liquid.

6. The material of claim 1 in which the MRE₂Tr₁₄X phase melts congruently on heating.

7. The material of claim 1 which is a ribbon or ribbon fragments.

8. The material of claim 1 which is atomized powder.

9. A permanent magnet material at least a portion of which includes a phase represented by MRE₂Tr₁₄X wherein MRE comprises Y and at least one other rare earth element and wherein Y plus at least one heavy rare earth element selected from the group consisting of Dy, Er, Ho, and Tb are present as 50% or more of the MRE on an atomic basis, Tr is a transition element, and X is an element selected from the group consisting of B and C.

10. The material of claim 9 wherein a majority by volume of said material comprises said phase.

11. The material of claim 9 wherein the transition element is selected from the group consisting of Fe and Co.

12. The material of claim 9 in which the MRE₂Tr₁₄X phase decomposes peritectically on heating to MRE₂Tr₁₇ phase plus a liquid.

13. The material of claim 9 in which the MRE₂Tr₁₄X phase melts congruently on heating.

14. The material of claim 9 which is a ribbon or ribbon fragments.

15. The material of claim 9 which is atomized powder.

16. The material of claim 9 wherein the ratio of Y to the heavy rare earth element is in the range of 0.5 to 3.0.

17. The material of claim 16 wherein the ratio of Y to the heavy rare earth element is about 1 to 1.

18. (canceled)

19. (canceled)

20. Permanent magnet material, comprising:
about 2 to about 20 atomic % Y,
about 1 to about 20 atomic % of least one other rare earth element wherein the total rare earth content is about 3 to 21 atomic %,
about 70 to about 96 atomic % Tr where Tr is a transition element, and
about 0.3 to about 5 atomic % X where X is selected from the group consisting of B and C.

21. The material of claim 20 in which a MRE₂Tr₁₄X phase decomposes peritectically on heating to MRE₂Tr₁₇ phase plus a liquid.

22. The material of claim 20 in which a MRE₂Tr₁₄X phase melts congruently on heating.

23. The material of claim 20 wherein said at least one other rare earth element is selected from the group consisting of Tb, Dy, Ho, and Er.

24. The material of claim 20 wherein said at least one other rare earth element is selected from the group consisting of Nd and Pr.

25. Permanent magnet material having a composition residing in the shaded area defined by a line extending between point A to point B, a line between point B to point C, a line between point C to point D, and a line extending from point D to point A of FIG. 18.

26. (canceled)

27. (canceled)

28. (canceled)

29. (canceled)

30. (canceled)
